(19) United States
(12) Patent Application Publication
(10) Pub. No.: US 2021/0216851 A1
(43) Pub. Date: Jul. 15, 2021

(54) EDGE DEVICE AND METHOD FOR ARTIFICIAL INTELLIGENCE INFERENCE

(71) Applicant: Electronics and Telecommunications Research Institute, Daejeon (KR)

(72) Inventors: Byung Bog LEE, Daejeon (KR); Woong Shik YOU, Sejong-si (KR); Gi Young LEE, Daejeon (KR); Cheol Sig PYO, Sejong-si (KR)

(73) Assignee: Electronics and Telecommunications Research Institute, Daejeon (KR)

(21) Appl. No.: 17/145,289

(22) Filed: Jan. 9, 2021

(30) Foreign Application Priority Data
Jan. 9, 2020 (KR) 10-2020-0002993
Feb. 12, 2020 (KR) 10-2020-0016882

(51) Int. Cl. G06N 3/04; G06N 3/08

(52) U.S. Cl. CPC G06N 3/0427; G06N 3/08

(57) ABSTRACT

According to one embodiment disclosed herein, an edge device may include: a sensor circuit capable of sensing a surrounding environment; and a processor, wherein the processor is configured to: obtain sensor data about the surrounding environment through the sensor circuit; identify a notification urgency of the sensor data by performing an inference based on a neural network graph via an artificial intelligence inference engine; and adjust a notification period of the sensor data depending on the identified urgency.

### CROSS-REFERENCE TO RELATED APPLICATION

This application claims the benefit of Korean Patent Application No. 10-2020-0002993, filed on Jan. 9, 2020 and Korean Patent Application No. 10-2020-0016882, filed on Feb. 12, 2020, in the Korean Intellectual Property Office, the disclosure of which is incorporated herein in its entirety by reference.

### BACKGROUND

### 1. Field

Various embodiments disclosed herein relate to an edge computing technology.

### 2. Description of Related Art

Conventional artificial intelligence systems provide a cloud-based service in which a central server processes all data.

As the Internet of Things (IoT) is popularized, data is rapidly increasing every month, and attempts to improve the AI inference rate are increasing. Such an edge computing technology has emerged in which an edge device having an inference function processes data in real-time by providing a self-inference on behalf of the Cloud.

### SUMMARY

An edge device (or an edge node) based on a general purpose processor (hereinafter, referred to as GPP), such as a CPU and an MCU, may be equipped with a pre-trained or re-trained artificial intelligence. The artificial intelligence may be implemented in field programmable devices (FPDs) such as field programmable gate arrays (FPGAs) or complex programmable logic devices (CPLDs). The FPDs may accelerate the speed of an artificial intelligence inference because the FPDs are capable of performing real-time processing and processing multiple complex artificial intelligence models and algorithms in parallel.

Various embodiments disclosed herein may provide an edge device and an artificial intelligence inference method that may infer a sensor data and adjust a notification period of the sensor data.

An edge device according to one embodiment disclosed herein may include a sensor circuit capable of sensing a surrounding environment, and a processor, wherein the processor is configured to: obtain sensor data about the surrounding environment via the sensor circuit; identify a notification urgency of the sensor data by performing an inference based on a neural network graph via an artificial intelligence inference engine; and adjust a notification period of the sensor data depending on the identified urgency.

Moreover, an edge device according to one embodiment disclosed herein may include: a sensor circuit capable of sensing a surrounding environment; a memory for storing at least one instruction; and a processor, wherein the processor is configured, by executing the at least one instruction, to: obtain sensor data about the surrounding environment via the sensor circuit; identify types of the surrounding environment by performing inferences based on a neural network graph via an artificial intelligence inference engine; and adjust a notification period of the sensor data depending on the type of the surrounding environment.

Furthermore, an artificial intelligence inference method according to one embodiment disclosed herein may include: obtaining sensor data for the surrounding environment; identifying a notification urgency of the sensor data through an artificial intelligence inference based on a neural network graph; and adjusting a notification period of the sensor data depending on the identified urgency.

According to various embodiments disclosed herein, it is possible to infer a sensor data and adjust a notification period of the sensor data. In addition, various effects which are directly or indirectly recognized through the disclosure may be provided.

### BRIEF DESCRIPTION OF THE DRAWINGS

FIG. 1 illustrates a schematic diagram of an artificial intelligence inference system according to an embodiment.

FIG. 2 illustrates a schematic diagram of an edge device according to an embodiment.

FIG. 3 illustrates an artificial intelligence inference method according to an embodiment.

In the context of the description of the drawings, the same or similar reference numerals may be used for the same or similar components.

### DETAILED DESCRIPTION

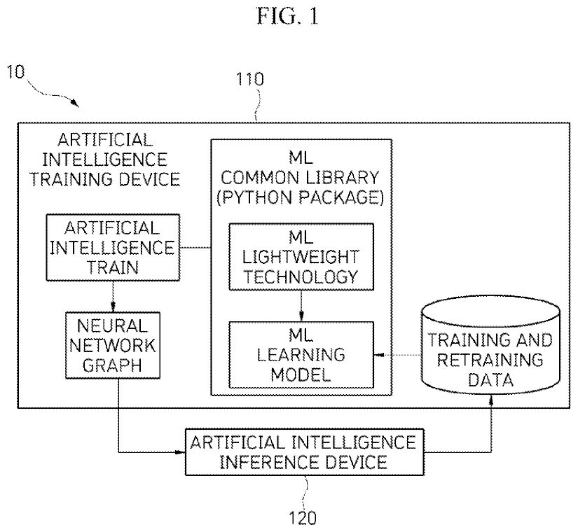

FIG. 1 illustrates a schematic diagram of an artificial intelligence inference system according to one embodiment.

Referring to FIG. 1, an artificial intelligence inference system 10 according to one embodiment may include an artificial intelligence training device 110 and an artificial intelligence inference device 120.

According to one embodiment, the artificial intelligence training device 110 may be a cloud server. For example, the artificial intelligence training device 110 may be a server with the standards shown in Table 1.

TABLE 1

| | |
|---|---|
| Operating System | linux, windows |
| Processor | CPU, GPU |
| AI Inference Engine | weighty |
| Power | outlet |
| Training & Inference Time | seconds to days |
| Serving Model | big |
| Python | Python (installed) |

The artificial intelligence training device 110 may perform an artificial intelligence training using mass data and generate a neural network graph as a result of the training of the artificial intelligence. For example, the artificial intelligence training device 110 may generate and store the neural network graphs as it refines the mass data (data pre-processing) and trains the artificial intelligence. In this regard, the artificial intelligence training device 110 may generate neural network graphs in the form of a data structure, such as a Natural Network Exchange Format (NNEF), an Open Natural network Exchange (ONNX), a ProtoBuffer, or a ByteBuffer, corresponding to the neural network data format. The artificial intelligence training device 110 may store the generated neural network graph in a file format. The mass data may be, for example, obtained from a plurality of devices (e.g., other artificial intelligence inference devices) including the artificial intelligence inference device 120.

The artificial intelligence training device 110 may obtain sensor data from the artificial intelligence inference device 120 and store and manage the obtained sensor data.

The artificial intelligence training device 110 may perform an artificial intelligence re-training using the sensor data obtained from the artificial intelligence inference device 120 at a designated time point and update the neural network graphs as a result of the re-training. The designated time point may include at least one among a time point according to a designated period, a time point according to the user's request, and a time point determined based on the obtained data. The time point identified from the obtained data may include, for example, a time point at which at least one situation from among an error occurrence situation, an abnormality situation, a dangerous situation, and an emergency situation is repeatedly identified.

According to one embodiment, the artificial intelligence inference device 120 may be an edge device including a hardware component of at least one of GPP and FPD. For example, the artificial intelligence inference device 120 may be a device having standards shown in Table 2 below.

TABLE 2

| | | |
|---|---|---|
| Operating System | non-os | android/iOS/linux/window |
| Processor | MCU | CPU, GPU, application processor |

| | |
|---|---|
| AI Inference Engine | light-weight |
| Power | battery |
| Training & Inference Time | milliseconds to seconds |
| Serving Model | small (light-weight) |
| Python | no-Python |

The artificial intelligence inference device 120 may include a sensor circuit and obtain the sensor data for the surrounding environment through the sensor circuit. The artificial intelligence inference device 120 may store the obtained sensor data in association with an acquisition time of the sensor data.

The artificial intelligence inference device 120 may be equipped with a neural network graph and an inference engine. The artificial intelligence inference device 120 may perform inferences on sensor data based on the neural network graph via the inference engine. The artificial intelligence inference device 120 may identify the types of the surrounding environment (recognize the surrounding situations) as a result of the inference. The artificial intelligence inference device 120 may identify urgency (or notification urgency) of the sensor data corresponding to the identified type. For example, the artificial intelligence inference device 120 may identify a risk level of the surrounding situation (or recognize the surrounding situation) by the inference on the sensor data. The artificial intelligence inference device 120 may consider the urgency of the sensor data being high if the identified risk level is high (or if the surrounding situation is dangerous).

The artificial intelligence inference device 120 may adjust the notification period of the sensor data depending on the urgency of the sensor data. For example, the artificial intelligence inference device 120 may set the notification period to be relatively short when the urgency of the sensor data is high. The artificial intelligence inference device 120 may set the notification period to be relatively long when the urgency of the sensor data is low.

The artificial intelligence inference device 120 may obtain a neural network graph or an updated neural network graph from the artificial intelligence training device 110 and be equipped with or update and then be equipped with the obtained neural network graphs.

According to the above-described embodiment, the artificial intelligence inference system 10 may reduce loads and costs for data transmission/reception by having the artificial intelligence not only in the cloud server but also in the edge device and selectively transmitting the sensor data relating to the situation awareness results only to the cloud servers.

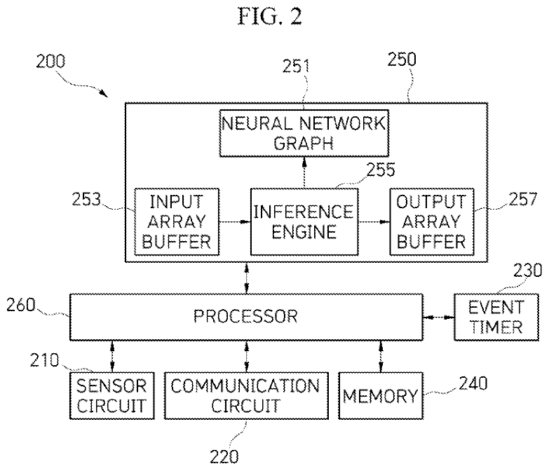

FIG. 2 illustrates a schematic diagram of an edge device (e.g., the artificial intelligence inference device 120 of FIG. 1) according to one embodiment.

Referring to FIG. 2, an edge device 200 according to one embodiment may include a sensor circuit 210, a communication circuit 220, an event timer 230, a memory 240, and a processor 260. In one embodiment, the edge device 200 may have some components omitted or may further include additional components. For example, the sensor circuit 210 may be configured as a separate device from the edge device 200 and may be configured to communicate with the edge device 200. In addition, some components of the edge device 200 may be combined to constitute a single entity, wherein the functions of the components prior to such combination may still be performed identically. The event timer 230 may be included in the processor 260. In one embodiment, the edge device 200 may be an IoT device.

The sensor circuit 210 may measure a physical quantity for the surrounding situation. The sensor circuit 210 may be a sensor that measures at least one of the various physical quantities, such as a temperature sensor, a humidity sensor, an anemoscope sensor, an acceleration sensor, or an angular velocity sensor.

The communication circuit 220 may support establishing communication channels or wireless communication channels between the edge device 200 and other devices (e.g., the artificial intelligence training device 110 of FIG. 1) and performing communication via the established communication channels. The communication channel may be a communication channel of a communication type such as, for example, a local area network (LAN), Fiber to the home (FTTH), x-Digital Subscriber Line (xDSL), Bluetooth, Wi-Fi, WiBro, 3G, or 4G.

The event timer 230 may count the designated notification periods and guide the arrival of the notification period to the processor 260 each time the set notification period has arrived.

The memory 240 may store various data used by at least one component (e.g., the processor 260) of the edge device 200. The data may include, for example, input data or output data for a software and instructions associated therewith. For example, the memory 240 may store at least one instruction for providing an artificial intelligence service. The memory 240 may include a volatile memory or a non-volatile memory.

The processor 260 may control at least one other component (e.g., a hardware or a software component) of the edge device 200 by executing at least one instruction and may perform various data processing or operations. The processor 260 may include, for example, at least one among a central processing unit (CPU), a graphics processing unit (GPU), a microprocessor, and an application processor and may have a plurality of cores.

The processor 260 may obtain an artificial intelligence execution code including an artificial intelligence neural network graph (hereinafter may be referred to as a “neural network graph”), a neural network input/output array buffer (hereinafter may be referred to as an “input/output array buffer”), and an artificial intelligence inference engine (hereinafter referred to as an “inference engine”) via the communication circuit 220.

The processor 260 may store the obtained artificial intelligence execution code in the memory 240 and generate an artificial intelligence module 250 based on the execution code. The artificial intelligence module 250 may be a software module.

The processor 260 may initialize the artificial intelligence by executing the stored artificial intelligence execution code. For example, the processor 260 may generate an instance of a neural network graph 251 and have the instance onboard in the memory 240 or the processor 260. In addition, the processor 260 may generate instances of an input array buffer 253, an output array buffer 257, and an inference engine 255.

The processor 260 may obtain sensor data (e.g., physical quantities) for the surrounding environment via the sensor circuit 210. Once having obtained the sensor data, the processor 260 may assign the sensor data to the input array buffer 253. The processor 260 may convert the sensor data into the input data structure of the neural network graph 251 via the input array buffer 253. The processor 260 may identify the type of surrounding environment as it performs inferences on the sensor data based on the neural network graph 251 via the inference engine 255. The processor 260 may assign the identified type to the output array buffer 257 and change the identified type to the specified data structure via the output array buffer 257. The identified type may relate, for example, to a notification urgency of the sensor data (or a risk level of the surrounding environment). The identified type may include others such as an emergency situation and a normal situation, for example. In the disclosure, for convenience of explanation, the identified type will be described as being either of an emergency situation or a normal situation as an example. However, it is not limited thereto. For example, the identified type may be one of three or more types. The specified data structure may include, for example, a data structure identifiable by the processor 260.

The processor 260 may adjust the event notification period depending on the identified type. For example, the processor 260 may set the event notification period to be shorter than or equal to a threshold period, e.g., 3 seconds, if the identified type is an emergency situation, and set the event notification period to be greater than the threshold period, e.g., 10 minutes, if the identified type is not an emergency situation. The processor 260 may set the event timer 230 as the adjusted event notification period.

If the processor 260 verifies that the identified type is an emergency situation, it may maintain the notification period to be shorter than or equal to the set threshold period until identifying the release of the emergency situation based on the sensor data.

The processor 260 may generate event data including an edge device identifier, a situation awareness event occurrence time, the sensor data, and the urgency-related information upon identifying the type of the surrounding environment based on the sensor data. The processor 260 may store the generated event data in the memory 240. The situation awareness event occurrence time may include, for example, a time point at which the sensor data is collected, a time point at which the type of the surrounding environment is identified, or a time point at which the event data is generated. The urgency-related information may include, for example, an identifier indicating the urgency, such as whether it is in an emergency situation or a normal situation.

The processor 260 may transmit the event data via the communication circuit 220 in accordance with the set notification period. For example, the processor 260 may transmit the event data in accordance with a notification period that is shorter than or equal to a threshold period when it is identified as an emergency situation based on the sensor data. For another example, the processor 260 may transmit the event data in accordance with a notification period that is greater than a threshold period when it is identified as not emergency situation based on the sensor data. In this regard, the processor 260 may transmit the event data in accordance with an event notification period guidance of the event timer 230.

The processor 260 may set the notification period below a threshold period regardless of the type of the surrounding environment if an update of the neural network graph 251 is required. For example, the processor 260 may identify a case where an update of the neural network graph 251 is required according to a command from the user or the artificial intelligence training device 110. In this case, the processor 260 may transmit the remaining event data except the event data already transmitted from among the event data stored in the memory 240 in accordance with the notification period shorter than or equal to the threshold period. Alternatively, the processor 260 may transmit all event data stored in the memory 240 in accordance with a notification period longer than or equal to a threshold period. In this regard, the artificial intelligence training device 110, upon receiving the event data of the edge device 200, may update the neural network graph by training the received event data. The artificial intelligence training device 110 may transmit the updated neural network graph to the edge device 200.

The processor 260 may receive the updated neural network graph from the artificial intelligence training device 110 and replace the neural network graph 251 with the updated neural network graph.

According to various embodiments, the processor 260 may transmit an event data related to an emergency situation and thereafter receive a reply from the artificial intelligence training device 110 that it is not an emergency situation. In this case, the processor 260 may count the number of errors depending on the received reply. If the errors are repeated more than a specified number of times, the processor 260 may identify on its own as to the artificial intelligence training device 110 a time point at which the neural network graph 251 needs to be updated.

According to various embodiments, the artificial intelligence module 250 may be mounted on a hardware component (Field programmable device, FPD) such as a Field Programmable Gate Array (FPGA) or a Complex Programmable Logic Device (CPLD). In this case, the artificial intelligence module 250 may store the artificial intelligence execution code including a neural network graph 251, an input/output array buffer 257, and an inference engine 255 implemented in a hardware description language (HDL) prior to an initialization of the edge device 200. The neural network graph 251, the input/output array buffer 257, and the inference engine 255 may be mounted to the hardware component via, for example, HDL Synthesis Tool. In this case, the processor 260 may perform inferences using the artificial intelligence module 250 mounted on the hardware component. Accordingly, the processor 260 may omit the initialization process of the neural network.

According to various embodiments, the artificial intelligence training device 110 may receive event data related to an emergency situation and may reconfirm if it is an emergency situation based on the corresponding event data to check whether an error has occurred. The artificial intelligence training device 110 may count the number of errors, and if the errors are repeated more than a specified number of times, it may identify the present time point as a time point at which an update of the neural network graph 251 is required and guide the result to the edge device 200.

According to the above-described embodiment, the artificial intelligence inference device 120 has an artificial intelligence not only on the cloud server (e.g., the artificial intelligence training device 110 of FIG. 1), but also on the edge device 200, and preferentially transmits the sensor data relating to the situation awareness results to the cloud server and transmits the remaining data all at once, thereby enabling reduction in data transmission/reception load and cost.

In addition, according to the above-described embodiment, the artificial intelligence inference device 120 may support responding quickly when an abnormal situation in the surrounding environment occurs by quickly transmitting the sensor data relating to the situation awareness results.

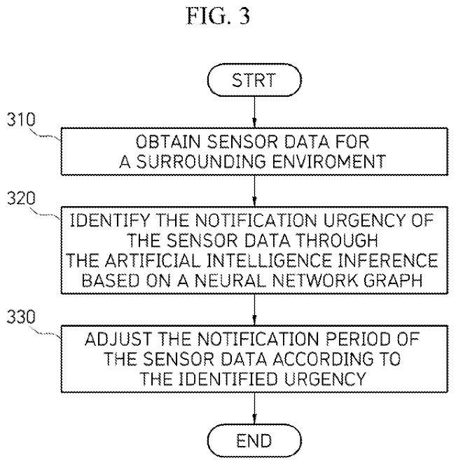

FIG. 3 illustrates an artificial intelligence inference method according to one embodiment.

Referring to FIG. 3, in operation 310, an edge device (e.g., the edge device 200 of FIG. 2) may obtain sensor data for a surrounding environment.

In operation 320, the edge device 200 may identify the notification urgency of the sensor data through the artificial intelligence inference based on a neural network graph. For example, the edge device 200 may assign the sensor data to the input array buffer 253 and convert the sensor data into an input data structure (or input shape) of the neural network graph via a neural network input buffer. The edge device 200 may perform inferences on the input values of the input array buffer 253 based on the neural network graph via the inference engine 255 and identify the urgency of the sensor data as a result of the inferences. Once the edge device has obtained the identified urgency-related information, it may assign it to the output array buffer and convert the urgency-related information into another specified data structure via the output array buffer 257. The above-mentioned another specified data structure may include a data structure which may be interpreted by the processor 260.

In operation 330, the edge device 200 may adjust the notification period of the sensor data according to the identified urgency. For example, the edge device 200 may set the notification period to be shorter than or equal to a threshold period if the type of the surrounding environment is identified as an emergency situation. The edge device 200 may then store the event data including an edge device identifier, a situation awareness event occurrence time, the sensor data, and the urgency-related information in the memory 240. The edge device 200 may transmit the stored event data to the artificial intelligence training device 110 in accordance with the notification period.

It is to be understood that the various embodiments of the present disclosure and the terms used therein are not intended to limit the technical features described in the disclosure to the specific embodiments, but include various modifications, equivalents, or alternatives of the embodiments. In connection with the description of the drawings, like reference numerals may be used for like or related components. The singular form of a noun corresponding to an item may include one or a plurality of such items unless the context explicitly specifies otherwise. In this document, each of the phrases such as “A or B,” “at least one of A and B,” “at least one of A or B,” “A, B, or C,” “at least one among A, B, and C,” and “at least one among A, B, or C” may include any one or all possible combinations of the items listed with the corresponding one of those phrases. Terms such as “first” and “second” or “firstly” and “secondly” may simply be used to distinguish a corresponding component from another corresponding component and do not limit the corresponding component in another aspect (e.g., importance or order). If a certain (e.g., a first) component is referred to as “coupled” or “connected” with or without the term “functionally” or “communicatively” to another (e.g., a second) component, it means that the certain component may be connected to the other component directly (e.g., by wires), wirelessly, or via a third component.

The terms “a module,” “a part,” and “a means” used herein may include a unit implemented as a hardware, a software, or a firmware, and may be used interchangeably with the terms such as, for example, a logic, a logic block, a component, or a circuit. The module may be an integrally composed component or a minimum unit or part of the component, which performs one or more functions thereof. For example, according to one embodiment, a module may be implemented in the form of an application specific integrated circuit (ASIC).

Various embodiments of the disclosure may be implemented as a software (e.g., a program) including one or more instructions stored in a storage medium (e.g., internal memory or external memory) (a memory 240) which is readable by a machine (e.g., an edge device 200). For example, a processor (e.g., a processor 260) of a device (e.g., an edge device 200) may call and execute at least one instruction of one or more stored instructions in a storage medium. This enables a machine to be operated to perform at least one function in accordance with the called at least one instruction. The one or more instructions may include a code generated by a compiler or a code executable by an interpreter. The machine-readable storage medium may be provided in the form of a non-transitory storage medium. Here, “non-transitory” merely means that the storage medium is a tangible device and does not include a signal (e.g., an electromagnetic wave), and such term does not distinguish between a case where data is indefinitely stored in the storage medium and a case where the data is temporarily stored.

According to one embodiment, a method according to various embodiments disclosed herein may be provided included in a computer program product. The computer program product may be traded between a merchant and a purchaser as a commodity. The computer program product may be distributed in the form of a machine-readable storage medium (e.g., a compact disc read only memory [CD-ROM]), or may be distributed directly between two user devices (e.g., smartphones) or on-line (e.g., downloaded or uploaded) via an application store (e.g., Play Store™). In the case of online distribution, at least a portion of the computer program product may be at least temporarily stored or temporarily created in a machine-readable storage medium, such as a manufacturer's server, a server in an application store, or a memory in a relay server.

According to various embodiments, each of the above-described components (e.g., a module or a program) may include a single entity or a plurality of entities. According to various embodiments, one or more of the corresponding components or operations described above may be omitted, or one or more other components or operations may be added. Alternatively or additionally, a plurality of components (e.g., modules or programs) may be integrated into a single component. In such a case, the integrated component may perform one or more functions of each one of the plurality of components in the same or similar manner as has (have) been performed by the plurality of components respectively prior to the integration. According to various embodiments, the operations performed by modules, programs, or other components may be executed sequentially, in parallel, repeatedly, or heuristically; one or more of the operations may be performed in a different order or be omitted; or one or more other operations may be added.

What is claimed is:

1. An edge device comprising:
a sensor circuit capable of sensing a surrounding environment; and
a processor, wherein the processor is configured to:
obtain sensor data for the surrounding environment via the sensor circuit;
identify a notification urgency of the sensor data by performing an inference based on a neural network graph via an artificial intelligence inference engine; and
adjust a notification period of the sensor data depending on the identified urgency.

2. The edge device according to claim 1, wherein the neural network graph and the inference engine are implemented in a software language and mounted on the processor or implemented in a hardware description language (HDL) and mounted on a field programmable device (FPD).

3. The edge device according to claim 1, wherein the processor is equipped with the artificial intelligence neural network graph generated by training previously obtained sensor data and equipped with the artificial intelligence inference engine.

4. The edge device according to claim 3, wherein the processor is further equipped with a neural network input buffer and is configured to:
assign the sensor data to the neural network input buffer in a case of obtaining the sensor data from the sensor circuit; and
convert the sensor data into an input data structure of the neural network graph via the neural network input buffer.

5. The edge device according to claim 3, wherein the processor is further equipped with a neural network output buffer and is configured to:
in a case of obtaining the identified urgency related information from the artificial intelligence inference engine, assign the urgency related information to the neural network output buffer; and
convert the urgency related information into another specified data structure via the neural network output buffer.

6. The edge device according to claim 1, wherein the processor is configured to set the notification period to be shorter than or equal to a threshold period if the processor identifies the surrounding environment as an emergency situation based on the identified urgency.

7. The edge device according to claim 6, wherein the processor is configured to maintain the set notification period until identifying a release of the emergency situation based on the sensor data.

8. The edge device according to claim 1, further comprising a communication circuit, wherein the processor transmits event data including an edge device identifier, a situation awareness event occurrence time, the sensor data, and the urgency-related information to a server in accordance with the notification period via the communication circuit.

9. The edge device according to claim 1, wherein the processor is configured to: set the notification period to be shorter than or equal to a threshold period if an update of the neural network graph is required; and transmit sensor data required for a re-training including the sensor data to a server.

10. The edge device according to claim 1, wherein the processor is configured to receive an updated neural network graph according to the re-training from the server and identify urgency of the sensor data based on the updated neural network graph.

11. An edge device, comprising:
a sensor circuit capable of sensing a surrounding environment;
a memory for storing at least one instruction; and
a processor, wherein the processor is configured, by executing the at least one instruction, to:
obtain sensor data for the surrounding environment via the sensor circuit;
identify types of the surrounding environment by performing inferences based on a neural network graph via an artificial intelligence inference engine; and
adjust a notification period of the sensor data depending on the type of the surrounding environment.

12. The edge device according to claim 11, wherein the neural network graph and the inference engine are implemented in a software language and mounted on the processor, or implemented in a hardware description language (HDL) and mounted on a field programmable device (FPD).

13. The edge device according to claim 11, wherein the processor is configured to set the notification period to be shorter than or equal to a threshold period if the type of the surrounding environment is identified as an emergency situation.

14. The edge device according to claim 13, wherein the processor is configured to maintain the set notification period until identifying a release of the emergency situation based on the sensor data.

15. The edge device according to claim 11, further comprising a communication circuit, wherein the processor is configured to:
store event data including an edge device identifier, a situation awareness event occurrence time, the sensor data, and the urgency related information in the memory; and
transmit the event data to a server in accordance with the notification period via the communication circuit.

16. The edge device according to claim 11, wherein the processor is configured to: set the notification period to be shorter than or equal to a threshold period if an update of the neural network graph is required; and transmit the sensor data required for re-training including the sensor data.

17. An artificial intelligence inference method by an edge device, the method comprising:
obtaining sensor data for the surrounding environment;
identifying a notification urgency of the sensor data through an artificial intelligence inference based on a neural network graph; and
adjusting a notification period of the sensor data depending on the identified urgency.

18. The method according to claim 17, wherein the adjusting comprises setting the notification period to be shorter than or equal to a threshold period if the type of the surrounding environment is identified as an emergency situation.

19. The method according to claim 17, further comprising:
storing event data including an edge device identifier, a situation awareness event occurrence time, the sensor data, and the urgency related information; and
transmitting the event data to a server in accordance with the notification period.

20. The method according to claim 17, further comprising:
setting the notification period to be shorter than or equal to a threshold period if an update of the neural network graph is required; and
transmitting the sensor data required for re-training including the sensor data.
